(19) United States
(12) Patent Application Publication
(10) Pub. No.: US 2024/0016584 A1
(43) Pub. Date: Jan. 18, 2024

(54) Dental Implants

(71) Applicant: Gerald A. Niznick, Las Vegas, NV (US)

(72) Inventor: Gerald A. Niznick, Las Vegas, NV (US)

(21) Appl. No.: 17/866,425

(22) Filed: Jul. 15, 2022

(51) Int. Cl. A61C 8/00

(52) U.S. Cl. CPC A61C 8/0037; A61C 8/0022; A61C 2008/0046

(57) ABSTRACT

Dental implants include a threaded body portion having a textured surface, and an externally smooth neck portion having one or more depth gauge lines to guide insertion into a patient's jawbone, with the neck portion projecting above the jawbone, allowing the gingival tissue to be sutured over the implant, or with the neck portion projecting through the gingival tissue.

### SUMMARY OF THE INVENTION

This invention relates to dental implants configured to project above a patient's jawbone, referred to as crestal bone, while still allowing the gingival tissue to be sutured over the top of the implant, or penetrate through the gingival tissue into the oral cavity upon placement in such a jawbone. These implants are configured to provide a dentist/dental professional flexibility in vertical placement of the implants in a patient's jawbone.

These implants include a body portion and an externally-smooth neck portion. The body of the implant may be straight or tapered, and may be threaded, or partially threaded, on the external surface. These implants are, preferably, about 7 to about 17 mm in length, and, more preferably, have a length of about 7 mm, about 9 mm, about 11 mm, about 12.5 mm, about 14 mm, and/or about 17 mm. All of these implants may be about 1 mm longer than the corresponding depth gauge score lines on standard dental drills.

The diameter of the neck portion of these implants may be in the range of about 3 mm to about 7 mm. Where the implant body is externally threaded, the threaded area may be about the same in diameter as the neck portion, narrower than the neck portion or wider in diameter than the neck portion.

The body's external surface may be textured, as by, for example, blasting with a resorbable material like hydroxyapatite crystals or a non-resorbable material like aluminum or titanium oxide. It may be coated over part or all of its external surface with hydroxyapatite.

The diameter of the body portion may be may be straight or taper down in diameter from its widest diameter. The implant may be made of a medical grade titanium alloy, commercially pure titanium or zirconia. The body portion may have one or more vertical or spiral grooves on its external surface to facilitate self-tapping insertion in the jawbone of a patient.

These implants preferably include an internal passage with an opening at the top of the neck portion of the implant. The opening, in preferred embodiments, may have a lead-in bevel ranging from 40 degrees to 85 degrees, forming what is called a conical connection, or can also be a butt joint or tube-in-tube configuration. The internal lead-in bevel can extend down from the opening, preferably over a length of about 0.5 mm to about 2.0 mm.

The passage extends inside the implant a vertical distance of about 4 to about 7 mm, and may be threaded to accept a one-piece healing collar or one-piece abutment with an externally threaded male projection or a two-piece abutment retained by an externally threaded fixation screw. Inside this passage, near the opening, may be a wrench engaging surface/structure, such as a hex-shaped, multi-lobed or slotted surface/structure to engage an insertion tool and male projections of abutments, configured to fit into the wrench engaging surface/structure.

The neck portion of the implant is substantially smooth on its external surface, and may be generally cylindrical in shape, or may flare wider, or taper narrower, near the top. The length of the neck may be about 2 mm to about 4 mm. In preferred embodiments, the neck portion may be about 2.5 mm to about 3 mm in length, and may include one or two circumferential score lines or laser marked lines, with the first line positioned about 1 mm below the top of the implant, the second line positioned about 2 mm below the top of the implant. These lines provide guidance in the placement of the implants in the jawbone of a patient.

For example, if the overall length of the implant is 14 mm, the textured implant body portion may be 11.5 mm in length, and the smooth neck portion may be 2.5 mm in length. Insertion of the implant to the depth of a socket created by penetration in the jawbone to the 13 mm depth gauge line on a standard dental implant drill leaves 1 mm of the smooth neck portion projecting above the patient's crestal bone, with 1.5 mm of the smooth neck below the crest of the patient's jawbone. As a result, the junction between implant and abutment will project 1 mm above the crest of the jawbone. This is a distance that will minimize the negative effects of micro-leakage from the abutment-implant junction. The smooth portion of the neck above the crest of the jawbone reduces the formation of plaque, as does the smooth portion below the crest of the jawbone, should bone recession occur.

After such implant placement, the gingival tissue above the crest of the patient's jawbone can be sutured over the implant for a 2-4 month submerged healing period that protects the implant froth premature loading, and from bacterial in the oral cavity. After the tissue is opened to expose the top of the implant, using a fixation screw, an abutment can be attached to support the restoration, or the restoration may be attached directly to the top of the implant.

Alternatively, a dental professional could penetrate into the jawbone using a standard implant drill to a depth of the 11.5 mm depth gauge score line, inserting the implant 11.5 mm in bone by stopping when the junction of the smooth neck and the textured body portion are level with the crest of the jawbone. This will leave 2.5 mm of the implant's smooth neck portion projecting above the crest of the patient's jawbone, which generally is high enough to penetrate through the gingival tissue. If not, a cover screw or healing collar can be attached for added height.

One of the advantages of the top of the implant placement at a 1 mm height above the crest of the jawbone and below the gingival tissue, referred to as 2-stage surgical protocol if the tissue is sutured over the implant, is that a crown constructed on an abutment or connected directly to the implant can have its margins placed sub-gingivally to more esthetically appear as a natural tooth.

One of the advantages of the neck placement projecting through the tissue at time of implant insertion, referred to as 1-stage surgical protocol, is that a second surgery to uncover the top of the implant is not needed. The advantage of the preferred embodiment, regardless whether a 1-stage or 2-stage protocol is used, or whether the implant is placed projecting 1 mm or 2.5 mm above the crest of the ridge, is that the first 1 mm of implant projecting above the crest of the patient's jawbone is a smooth surface ideal for soft tissue attachment.

This attachment will not be disturbed when a healing collar, transfer or abutment is attached to, or removed from, the top of the implant. This undisturbed soft tissue attachment zone in the first 1 mm above, the crest of the ridge, serves as a barrier to bacterial attack from the oral cavity.

These dental implants are configured to give a dentist flexibility in vertical placement in the jawbone, and to minimize or prevent peri-implantitis, which can lead to bone loss and ultimate implant failure. This is accomplished, in preferred implant embodiment, in which the implant is 1 mm longer than the lengths of the standard depth markings at 6, 8, 10, 11.5, 13 and 16 mm, as measured from near the cutting tip of the drill.

These preferred embodiments include a neck portion, with the prescribed length and depth gauge score or laser lines, that guide a dentist in placing the smooth neck portion partially below, partially above, or both, in relationship to the crest of a patient's jawbone ridge, while placing the implant-abutment junction above that crest, or extending entirely above the crest of the jawbone, and projecting through the gingival tissue. The cylindrical neck portion of these implants also provides a dentist the option to place the top of the implant level with the crest of the jawbone. This may be indicated if recession of the bone is anticipated because of the narrow width of the jawbone, or because bone grafting was needed to till a bony defect near the top of the jawbone.

As a result, upon placement, these new implants can also provide a smooth segment of the neck portion below the crest of a patient's jawbone to compensate for post-placement jawbone loss, while also giving a smooth surface above the crest of the jawbone ridge for an undisturbed soft tissue attachment, reducing post-placement bone loss. In addition, placing the implant-abutment junction above the crest of the ridge of a patient's jawbone, rather than at the crest of the ridge, helps negate complications from micro-leakage at the implant abutment junction, further helping to preserve crestal bone, which in turn minimizes peri-implantitis.

The smooth neck portion of the implant is long enough that if the implant's textured body surface is placed level with the crest of the ridge, a dentist can restore the implant in 1-surgical stage, leaving the neck portion projecting through the gingival tissue with a cover screw or healing collar attached.

Several factors may influence, and dictate, a desirable vertical position far the neck of the implant, such as the thickness of a patient's available bone, a patient's oral hygiene, bone defects requiring grafting, initial stability, thickness of gingival tissue, the presence of attached gingiva, the choice of a one-stage or two-stage restoration and the choice of immediate or delayed loading of the implant.

The new implants provide the option, and the flexibility, at time of implant placement, for the dentist to decide whether to use a 1-stage or 2-stage surgical protocol and how much, if any, of the smooth neck is deemed advisable to be placed above the crest of the jawbone. Placing the textured surface on the body of the implant, level with the crest of bone has proven successful if adequate thickness of bone surrounds the implant and if the tissue is of adequate thickness to forma soft-tissue seal to the smooth neck or smooth surface of a healing collar projecting through the soft tissue.

Whether 1 mm or 2.5 mm of the implant's neck portion is projecting above the crest of the patient's jawbone, distancing the implant-abutment junction from the point of penetration of the drill into the jawbone may reduce soft tissue inflammation from leakage of endotoxins that tend to form in the internal shaft of an implant, and will result in at least 1 mm of smooth neck projecting above the crest of the jawbone, for a zone of soft tissue attachment which will not be disturbed when attaching abutments and transfers.

### BRIEF DESCRIPTION OF THE DRAWINGS

An exemplary embodiment of invention is described in the following detailed description of the drawings, in which:

FIG. 1 is an elevation view of an exemplary embodiment of an implant of this invention; and

FIG. 2 is an elevation view of the implant of FIG. 1, shown in vertical cross-section.

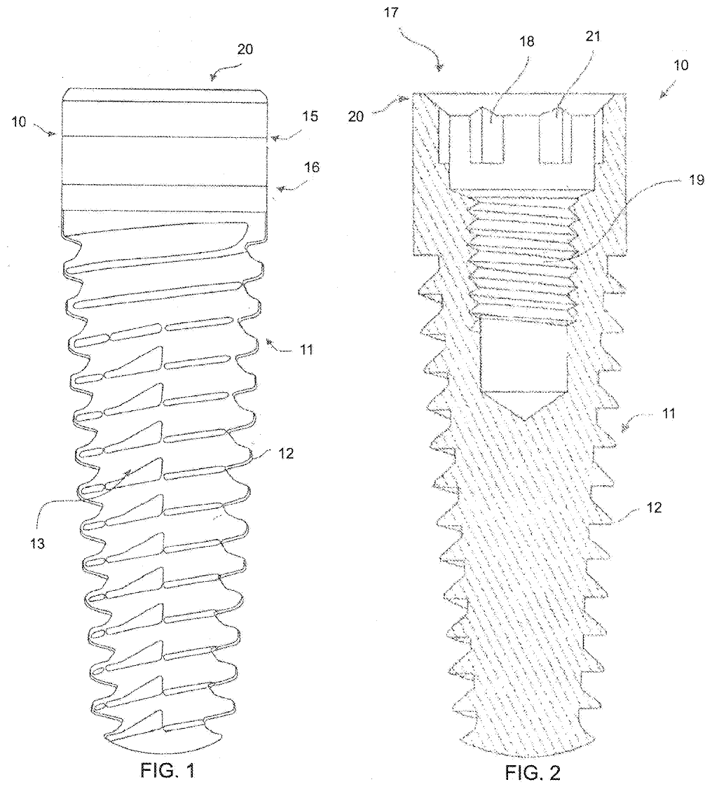

### DETAILED DESCRIPTION OF THE DRAWINGS

The drawings show an exemplary, non-limiting embodiment 10 of the new dental implants. Implant 10 includes tapered body portion 11, and, atop body portion 10, neck portion 14. Body portion 11 is externally threaded, includes threads 12 along its length, and is tapered along its length, below neck portion 14. Body portion 11 includes vertical groove 13 that facilitates self-tapping insertion of implant 10 in the jawbone of a patient.

Neck portion 14 is substantially cylindrical in shape along its length, includes two circumferential score lines 15 and 16, located about 1 mm and about 2 mm, respectively, below the top 20, of implant 10. Lines 15 and 16 provide guidance in the placement of the implants in the jawbone of a patient. For example, with an implant that is configured to accept an abutment after implant placement, if the implant body portion is 13 mm in length, and the neck portion is about 1 mm in length, using a 13 mm drill leaves the neck portion, about 1 mm in length, projecting above the bone. As a result, the junction between implant and abutment is spaced from crestal bone.

Inside implant 10, as FIG. 2 shows, is passage 17, with its opening at the top 20 of neck portion 14. Inside this opening, on the surface of the passage, is beveled, circumferential surface 21. Below beveled surface 21 is wrench-engaging surface/structure 18, here, hex-shaped surface to receive and engage a tool of complementary shape and size to screw, or otherwise place, implant 10 into the jawbone of a patient. Below wrench-engaging surface/structure 17 is threaded passage portion 19, configured to engage an abutment with complementary threads on its external surface.

While this invention has been described in conjunction with the exemplary embodiments outlined above, the foregoing description of exemplary embodiments of the invention, as set forth above, is illustrative, not limiting. The invention is not necessarily so constrained. Many alternatives, adaptations modifications, and/or variations may be apparent to those skilled in the art.

Where a range of values is provided, every intervening value, between the upper and lower limit of that range and any other stated or intervening value in that stated range is included within the invention. The upper and lower limits of these smaller ranges may be included in the smaller ranges, and are likewise included within the invention. Where the stared range includes one or both of the limits, ranges excluding either or both of those included limits are also included in the invention

In this specification and in the appended claims, the singular forms “a”, “and”, “said”, and “the” include plural referents unless the context clearly dictates otherwise. The claims may be so-drafted to require singular elements or exclude any optional element. These statements provide antecedent basis for use of such exclusive terminology as “solely”, “only”, and the like in connection with the recitation of claim elements, and/or the use of “negative” claim limitation(s).

1-8. (canceled)

9. A dental implant for use with an abutment including a threaded or partially threaded body portion distal to, and distinct from, a cylindrical, externally smooth neck portion atop said body portion, said neck portion including an internal passage with an opening to said internal passage at the top of said neck portion, and with a top surface cross section at a right angle to the vertical axis of said dental implant configured, on its external surface, said otherwise externally smooth neck portion including at least two circumferential depth gauge lines that are parallel to said top surface, and are at a right angle to the vertical axis of said dental implant, and that are spaced apart a first distance from said top surface, said first distance being perceptible/visible to a user of said dental implant, and, separately, a second distance from one another, said second distance also being perceptible/visible to a user of said dental implant, to guide and facilitate positioning of said neck portion, upon placement of said implant in a socket in a patient's jawbone, in at least two different jawbone socket depths corresponding to the location of said two circumferential depth gauge lines, to project at a desired height above and below the crest of said patient's jawbone, wherein said at least two circumferential depth gauge lines depth gauge lines are selected from the transition between said externally smooth neck portion and said body portion, and from one or more circumferential depth gauge lines formed on said externally smooth neck portion, and below said top surface.

10. The dental implant of claim 9 where the overall lengths of the body portion and the neck portion are 1 mm longer than the depth of a socket prepared in said patient's jawbone, using various depth gauge lines on commonly used dental implant drills.

11. The dental-implant of claim 9 wherein said body portion has a textured surface, and, upon said placement, said neck portion projects above the crest of said jawbone, and, in part, below the crest of said jawbone.

12. The dental implant of claim 9 wherein said neck portion has a length in the range of about 1 mm to about 3 mm, said lines extending circumferentially around at least a portion of said neck portion, said lines being spaced apart from one another by at least one millimeter.

13. (canceled)

14. (canceled)

15. (canceled)

16. The implant of claim 9 wherein said neck portion flares wider, or tapers narrower, near the top of said neck portion.

17. The dental implant of claim 9 wherein said neck portion includes at least two of said depth gauge lines, with both lines positioned below the top of said dental implant, at least one of said depth gauge lines positioned above the distal end of said externally smooth neck portion, and each of said depth gauge lines extending circumferentially around at least a portion of said neck portion, said lines being spaced equidistant from one another.

18. The dental implant of claim 9 wherein said neck portion includes at least two of said depth gauge lines, with one line positioned below the top of said dental implant, and one millimeter below said top surface, and a second depth gauge line positioned 1 millimeter distal to said one line, above the boundary between said externally smooth neck portion and said body portion.
